(19) United States
(12) Patent Application Publication
(10) Pub. No.: US 2013/0073341 A1
(43) Pub. Date: Mar. 21, 2013

(54) PRICING MARKDOWN OPTIMIZATION SYSTEM

(71) Applicants: Andrew VAKHUTINSKY, Norwood, MA (US); Alexander KUSHKULEY, Acton, MA (US); Manish GUPTE, Burlington, MA (US)

(72) Inventors: Andrew VAKHUTINSKY, Norwood, MA (US); Alexander KUSHKULEY, Acton, MA (US); Manish GUPTE, Burlington, MA (US)

(73) Assignee: ORACLE INTERNATIONAL CORPORATION, Redwood Shores, CA (US)

(21) Appl. No.: 13/235,919

(22) Filed: Sep. 19, 2011

(51) Int. Cl. G06Q 10/00

(52) U.S. Cl. 705/7.35

(57) ABSTRACT

A system determines a revised price on a pricing ladder for a product over a pricing markdown period. For a first time interval of the markdown period, the system computes an optimal price for the product based on an inventory level of the product, where the inventory level is based on a ratio of a current on-hand inventory and a maximal on-hand inventory. The system then determines if the optimal price is approximately less than a current price of the product. When the optimal price is approximately less than a current price of the product, the system assigns to the product a lower price on the price ladder as the current price of the product.

### FIELD

One embodiment is directed generally to a computer system for determining product pricing, and in particular to a computer system that determines optimized product pricing markdowns.

### BACKGROUND INFORMATION

For a retailer or any seller of products, at some point during the selling cycle a determination will likely need to be made on when to markdown the price of a product, and how much of a markdown to take. Price markdowns can be an essential part of the merchandise item lifecycle pricing. A typical retailer has between 20% and 50% of the items marked down (i.e., permanently discounted) and generates about 30-40% of the revenue at marked-down prices.

A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle.

### SUMMARY

One embodiment is a system that determines a revised price on a pricing ladder for a product over a pricing markdown period. For a first time interval of the markdown period, the system computes an optimal price for the product based on an inventory level of the product, where the inventory level is based on a ratio of a current on-hand inventory and a maximal on-hand inventory. The system then determines if the optimal price is approximately less than a current price of the product. When the optimal price is approximately less than a current price of the product, the system assigns to the product a lower price on the price ladder as the current price of the product.

### BRIEF DESCRIPTION OF THE DRAWINGS

FIG. 1 is a block diagram of a computer system that can implement an embodiment of the present invention.

FIG. 2 is a graph that illustrates the inventory effect on the cumulative revenue in accordance with one embodiment.

FIG. 3 is a flow diagram of the functionality of the pricing markdown module of FIG. 1 when determining an optimized pricing markdown in accordance with one embodiment.

FIG. 4 is a graph illustrating an example of markdown optimization in accordance with one embodiment.

### DETAILED DESCRIPTION

One embodiment is a pricing markdown optimizer that determines an optimized markdown while taking into account an inventory effect. Embodiments apply a price control assuming that price and time are continuous, and then determines how the price can be modified when the price and time are discreet.

In one embodiment, pricing markdown can be determined by solving a “markdown optimization problem.” The objective of the markdown optimization problem can be to find a monotonically decreasing sequence of merchandise prices that maximizes the revenue by taking into account inventory constraints and demand dependence on time period, price and inventory effects.

The mathematical formulation of the markdown optimization problem can be defined in one embodiment as:

$$max {\sum }_{t = 1}^{T} {p}_{t} {s}_{t}$$

subject to :

sₜ≦dₜ(I₀, p₁, . . . , pₜ, d₁, . . . , dₜ₋₁) ∀t=1, . . . , t

sₜ≦Iₜ₋₁

Iₜ=Iₜ₋₁−sₜ

where:
T is the length of the markdown period, usually measured in weeks;
sₜ is the sales volume in period t;
pₜ is the sales price at period t, which is the decision variable;
Iₜ is the inventory level at the end of time period t, I₀ is given as part of the input; and
dₜ( . . . ) is the demand, which in general is a function of past and present price settings, initial inventory, and demand in previous periods. The objective of the optimization problem is to maximize the total revenue.

In one known pricing markdown optimizer, “Retail Markdown Optimization (MDO)”, version 13.2, from Oracle Corp., a number of simplifying assumptions is made regarding the demand to solve the markdown optimization problem, which results in the following expression for the demand function:

d(t, p I)=k dₚ(p)d_{I}(I)s(t)δ(t)=k(p/p_{f})^{γ}(I/I_{c})^{α}s(tδ(t)

where the components of the demand function are as follows:

Price Effect, dₚ(p): captures the sensitivity of demand to price changes. It is modeled as an isoelastic function of price p with constant elasticity γ<−1, dₚ(p)=(p/p_{f})^{γ}where p_{f} is the full price of the item;

Inventory Effect, d_{I}(I): also known as the “broken-assortment effect”, which occurs when willing-to-pay customers cannot find their sizes/colors. It is modeled as a power function of on-hand inventory I, d_{f}(I)=(I/I_{c})^{α}, where I_{c} is the critical inventory of the item;

Seasonality, s(t): seasonal variation of demand due to holidays and seasons of the year; shared by similar items;

Base demand, k: the scaling coefficient expressing the overall strength of the demand;

Random fluctuations, δ(t): random process expressing the stochastic nature of the consumer demand.

The demand model parameters are fitted by estimating base demand, k, price elasticity, γ, and inventory effect power, α, via regression on multiple sales data points with known price, inventory and seasonality. However, this demand model is based on an exhaustive search. Therefore, its implementation is impractical due to exponential amount of calculations required at run time unless the number of planned markdown price changes is limited to two. However, this limitation makes it difficult or impractical to account for the inventory effect, which requires multiple price markdowns and therefore would require an enormous amount of calculations.

In contrast, in one embodiment of the present invention, the demand dₜ( . . . ) is modeled so that it takes into account the adverse effect of inventory depletion on the consumer demand (i.e., the broken-assortment effect). For example, if the demand is modeled for a merchandise item at an aggregate level, which may include, for example, several sizes or colors of the same style, then as inventory level decreases, specific sizes/colors may be out of stock even though there is a positive inventory for the entire item. The resulting reduction in alternatives reduces the sales rate at any given price when customers willing to pay the price for the item cannot find their specific size or color.

In one embodiment, the markdown optimization problem is solved for a vendor that is assumed to have to sell a merchandise item that includes several sizes and colors before a certain end-of-season date. The item sales period starts with known initial inventory and no further replenishments are allowed. All markdowns are permanent so that once the price is reduced, it cannot be increased back. One embodiment utilizes a closed-form analytical expression to compute optimal price as a function of time by solving the markdown optimization problem with continuous time and price as an isoperimetric problem. Based on this expression, in one embodiment a tractable approximate solution to the markdown optimization problem is obtained with discrete price and time.

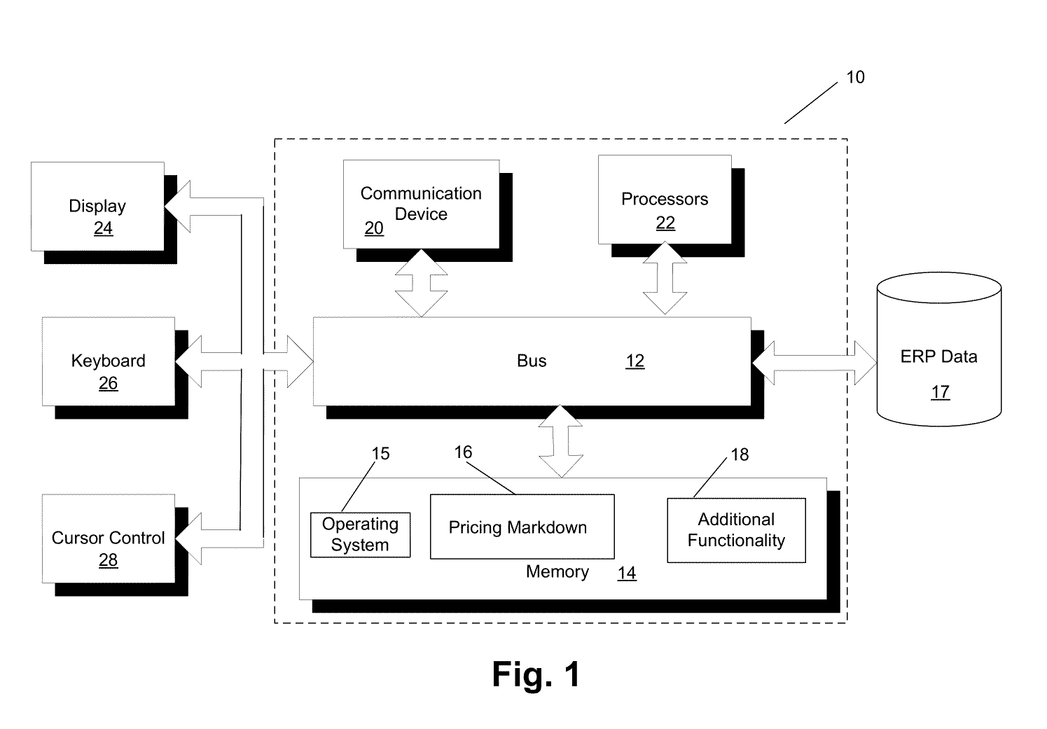

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a pricing markdown module 16 that determines an optimized pricing markdown while accounting for inventory effects, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing data and ERP data such as inventory information, etc.

In general, the inventory effect is related to the ratio between current on-hand inventory and maximal on-hand inventory. As the ratio decreases so does the inventory effect factor in the demand function, which in turn drives the entire demand function to zero.

Further, the inventory depletion in general affects the cumulative revenue when the price of the merchandise is kept constant. For example, assume for simplicity that there are no demand fluctuations or seasonality effects so that there is a constant price. Since the change in the inventory level is affected only by demand, the inventory level as a function of time can be obtain by solving the following differential equation where p₀ is the constant initial price:

−dI/dt=k(p₀/p_{f})^{γ}s(t)*i/I_{c})^{α}

For any time t>0 denote the average seasonality

$$σ ( t ) = \frac{1}{t} {\int }_{0}^{t} s ( u ) d u$$

The solution to the above equation is as follows (“equation (1)”):

$$I ( t ) = \{ \begin{matrix}{{I}_{0} ( 1 + ( α - 1 ) \frac{Kt σ ( t )}{{I}_{0}} )}^{\frac{1}{1 - α}} , & if α \neq 1 \\ {I}_{0} {e}^{- Kt σ ( t ) / {I}_{0}} , & if α = 1\end{matrix} \\ where K = {k ( \frac{{p}_{0}}{{p}_{f}} )}^{γ} {( \frac{{I}_{0}}{{I}_{c}} )}^{α} , \qquad ( 1 )$$

which results in the following expression for the cumulative revenue as a function of time:

$$R ( t ) = {p}_{0} ( {I}_{0} - I ( t ) ) = \{ \begin{matrix}{p}_{0} {I}_{0} ( 1 - {( 1 + ( α - 1 ) \frac{Kt σ ( t )}{{I}_{0}} )}^{\frac{1}{1 - α}} ) , & if α \neq 1 \\ {p}_{0} {I}_{0} ( 1 - {e}^{- Kt σ ( t ) / {I}_{0}} ) , & if α = 1\end{matrix}$$

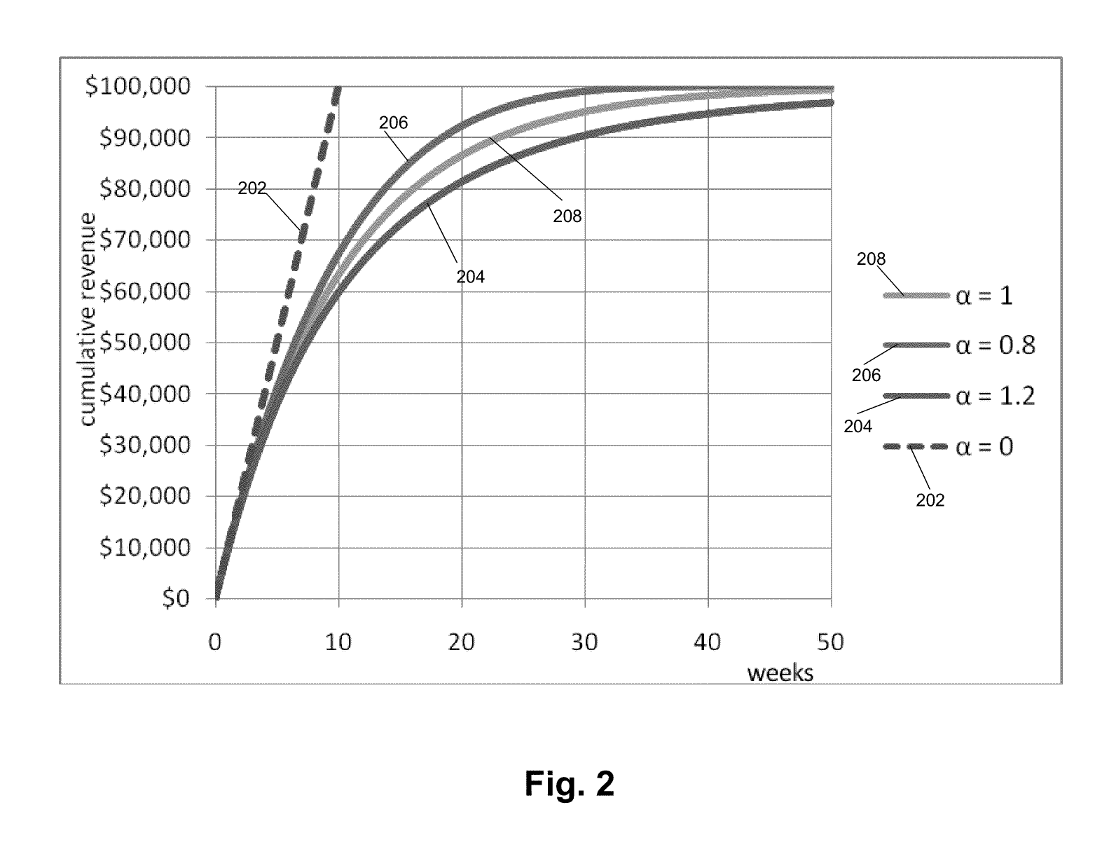

FIG. 2 is a graph that illustrates the inventory effect on the cumulative revenue in accordance with one embodiment. In this example, the parameter values are set as follows: p₀=$100; I₀=1000; K=100. The revenue is plotted for a period of fifty weeks for various levels of inventory effect power settings: α=0.8 (206), 1.0 (208), 1.2 (204) and α=0 (202), where the latter implies no inventory effect. As shown on dotted line 202, with no inventory effect, at 10 weeks the revenue is $100,000. However, with the various inventory effects, the revenue at 10 weeks falls to approximately $60,000-70,000, depending on the inventory effect power setting.

In one embodiment, rather than assuming a constant price as in the example above, a novel price control is used to allow maximizing the cumulative revenue within given time period. As disclosed below, the price control can be applied in the case when price and time are continuous, and then it can be modified in the case when price and time are discreet.

### Continuous Price and Time

In one embodiment, for the case when price and time are continuous, let T denote the markdown season length, θ=−(γ+1)/α and τσ(τ)=θI₀/(K(θ+1). Then if T=τ, the optimal price control to maximize the cumulative revenue within time period T is expressed according to the following equation (“equation (2)”):

$$p ( t ) = {{p}_{0} ( 1 - \frac{σ ( t )}{σ ( T )} \frac{t}{T} )}^{\frac{1}{θ + 1}} \qquad ( 2 )$$

If the price is controlled according to equation (2), then the inventory at time t is:

$$I ( t ) = {{I}_{0} ( 1 - \frac{σ ( t )}{σ ( T )} \frac{t}{T} )}^{\frac{1}{θ + 1}}$$

and the optimal revenue when the inventory is cleared at time T=τ becomes:

$${R}^{*} ( T ) = \frac{q}{q + 1} {p}_{0} {I}_{0}$$

If T≠τ, the price control is not smooth anymore and becomes the following:
If T<τ, set

$${p}_{0} := {p}_{0} ( \frac{σ ( T ) T}{σ ( T ) T} ) \text{?}$$

$$\text{?} \text{indicates text missing or illegible when filed}$$

and apply price control equation (2);
if T>τ, then consider two cases:
(i) If α<1 and

$$T σ ( T ) > \frac{{I}_{0}}{K ( 1 - α )}$$

keep constant price p(t)=p₀ till the end of the sales period. In this case the inventory stock will be cleared at the time t_{f} such that

$${t}_{f} σ ( {t}_{f} ) = \frac{{I}_{0}}{K ( 1 - α )} .$$

(ii) Otherwise, keep constant price p(t)=p₀ until time tₛ determined by the following equation (“equation (3)”):

$${t}_{s} σ ( {t}_{s} ) = \frac{1}{γ} ( \frac{θ {l}_{0}}{K} - ( θ + 1 ) T σ ( T ) ) \qquad ( 3 )$$

Then apply price control equation (2). In this case the inventory stock is cleared exactly at time T.

### Discrete Price and Time

In one embodiment, when the price and time are discrete, the price comes from a pricing ladder and is subject to periodic (e.g., weekly) review and update. The pricing ladder can be a schedule of prices used by the seller. The periodic review can be based on a schedule of dates when a seller commences the markdown of prices. In this embodiment, the periodic price update is designed to track the optimal price curve for continuous time and price. Since the price stays constant between the updates, the inventory diminishes according to equation (1) above. In one embodiment, the following three-step procedure is applied at each point of the periodic review and update process:
1. Given the current inventory level, merchandise price, and time to finish the sales, determine the optimal price to complete the sales by the end time with maximal revenue.
2. If the optimal price is approximately equal or less than the current price, lower the current price according to the price lowering rules disclosed below. These rules are determined by the specific setting of the certain set of parameters.
3. If the optimal price is significantly greater than the current price, keep the current price unchanged.

### Price Lowering Rules

In one embodiment, the following price lowering rules are used to determine an optimal price if it should be lower than the current price:
1. Denote the inventory level and price at the current time t of the periodic review by I(t) and p(t), respectively. Since in this case the time is discrete, the average seasonality effect prior to time t period is now defined as

$$σ ( t ) = \frac{1}{t} {\sum }_{u = 1}^{t} s ( u )$$

2. Compute the optimal price p*(t) to sell the current inventory within the remaining time (T−t) with maximum revenue as follows (“equation (4)”):

$${p}^{*} ( t ) = {{p}_{f} ( \frac{θ}{θ + 1} \frac{I ( t )}{k ( T σ ( T ) - t σ ( t ) )} )}^{1 / γ} {( \frac{{I}_{c}}{I ( t )} )}^{α / γ} . \qquad ( 4 )$$

3. If p*(t)<p(t), find two adjacent prices p₁ and p₂ from the price ladder such that p₁<p*(t)≦p₂ and set the current price p(t) to one of these ladder prices depending on how the ratio (p*(t)-p₁)/(p₂-p*(t)) compares to a certain pre-selected threshold parameter, which may be set to different values for different time periods.
4. If p*(t)≈p(t) and α>1, find the switchover time tₛ determined by equation (3) above with I₀=I(t).

Decide whether to lower the current price p(t) to the next price in the ladder depending on how the ratio of (tₛ-t)/(tₙₑₓₜ-tₛ) compares to a threshold parameter, which, similar to the other threshold parameter, may vary with the time period. Here, tₙₑₓₜ is the time of the next periodic review.

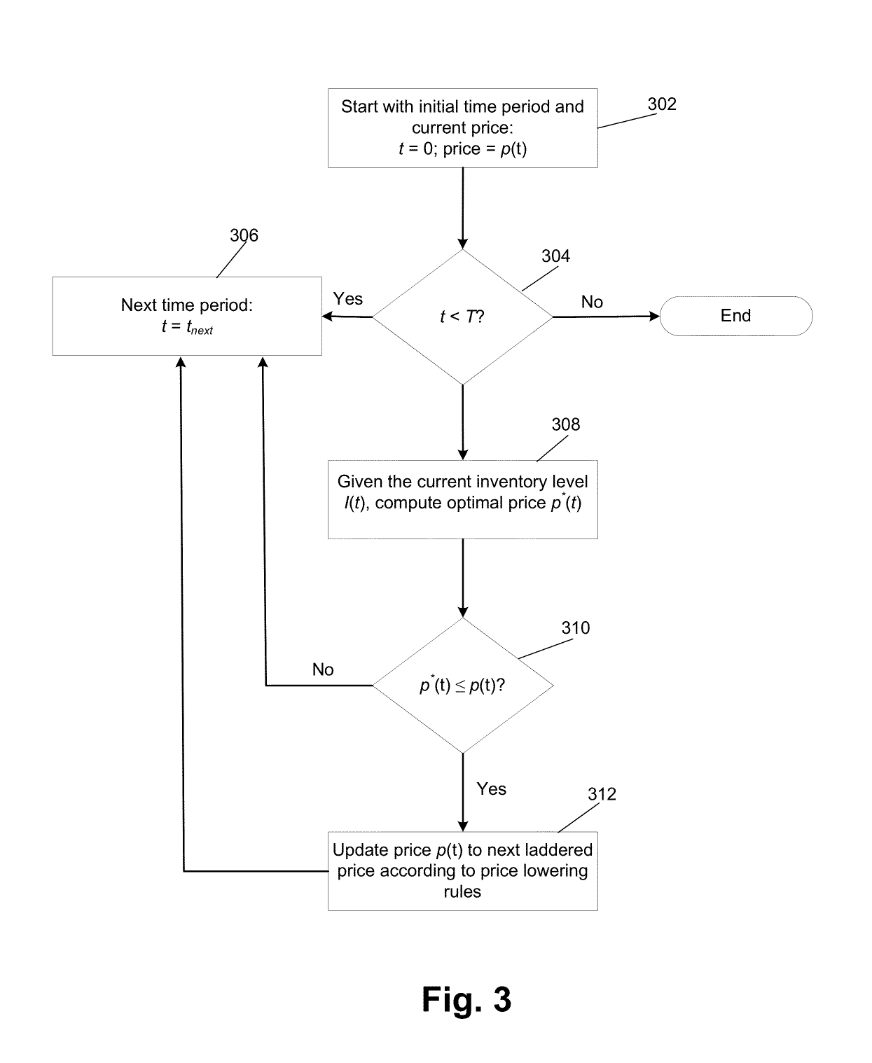

FIG. 3 is a flow diagram of the functionality of pricing markdown module 16 of FIG. 1 when determining an optimized pricing markdown in accordance with one embodiment. The pricing markdown of FIG. 3 involves discrete price and time so that the prices are selected from a pricing ladder and is subject to periodic review and update. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, the functionality starts with an initial time period, t=0, and a current price, p(t). “t” is a time variable used to express evolution of inventory level, price, and revenue as functions of time.

At 304, it is determined if t<T. If no at 304, the functionality ends because the markdown season length has expired.

If yes at 304, at 308, the optimal price p*(t) is determined, using equation (4) disclosed above, for the current inventory level I(t). I(t) is based on a ratio of a current on-hand inventory and a maximal on-hand inventory.

At 310, it is determined if the optimal price is less than or approximately equal to the current price. If no at 310, at 306 the next time period is reached and functionality continues at 304.

If yes at 310, at 312 the current price is updated/revised (i.e., marked down) to a new price on the pricing ladder (if the rules result in a lowering) based on the pricing rules disclosed above. Functionality then continues at 306.

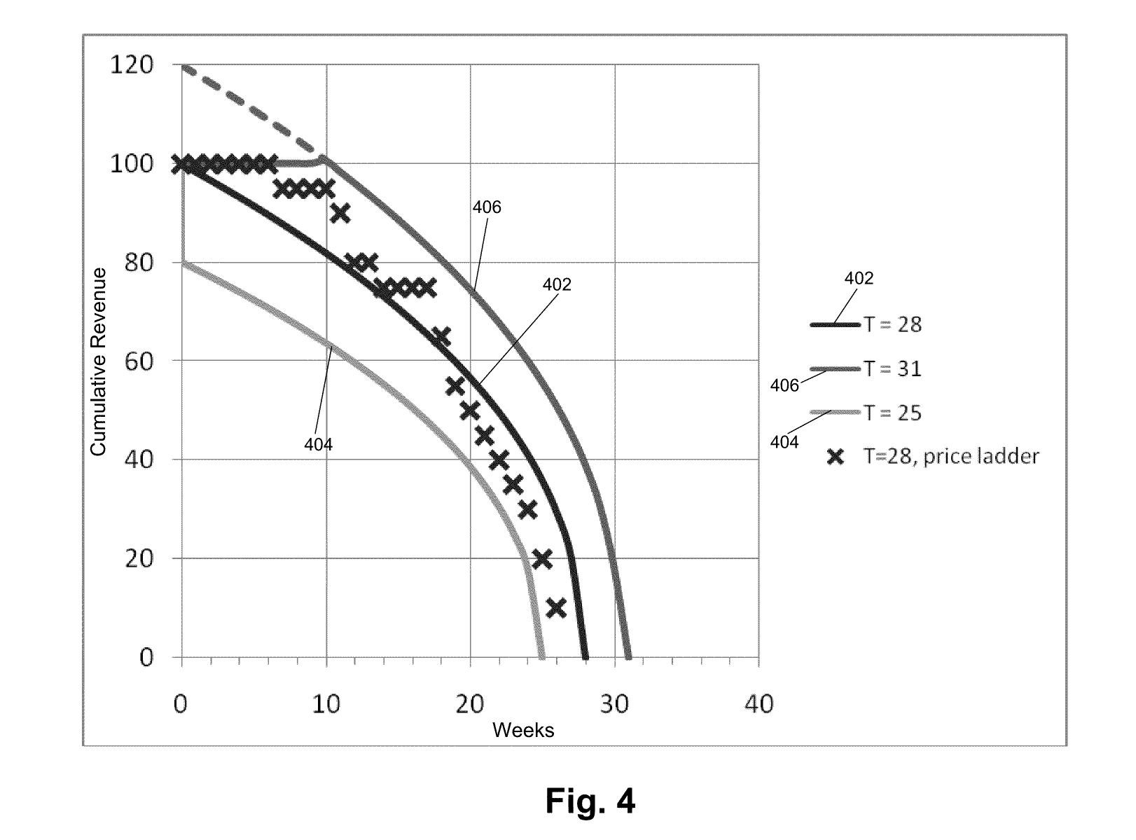

FIG. 4 is a graph illustrating an example of markdown optimization in accordance with one embodiment. In the example of FIG. 4, p₀=$100; I₀=1000; K=20; α=0.8; γ=−2; and π=28 weeks. In the graph, the solution obtained by applying discrete price and time policy is marked by ‘x’. The results are as follows:
T=T=28 weeks: keep on the optimal trajectory (line 402);
T=25 weeks: optimal trajectory starts at discounted price of $80 (line 404);
T=31 weeks: price constant until it reaches optimal trajectory (line 406).

As disclosed, embodiments provide markdown pricing optimization while accounting for inventory effects. The embodiments allow for a fast, scalable, and overall robust approach. Because of the streamline solution, embodiments can be implemented within a database using a Structured Query Language (“SQL”) such as Procedural Language (“PL”) SQL from Oracle Corp., rather than requiring an application server. Further, most business rules can be easily incorporated within embodiments.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to determine a revised price on a pricing ladder for a product over a markdown period, the instructions comprising:
for a first time interval (t) of the markdown period (T), compute an optimal price (p*(t)) for the product based on an inventory level (I(t)) of the product, wherein the inventory level is based on a ratio of a current on-hand inventory and a maximal on-hand inventory;
determine if the optimal price is approximately less than a current price (p(t)) of the product; and
when the optimal price is approximately less than a current price of the product, assigning a lower price on the price ladder as the current price of the product.

2. The computer readable medium of claim 1, wherein the inventory level comprises:
$$I ( t ) = {{I}_{0} ( 1 - \frac{σ ( t )}{σ ( T )} \frac{t}{T} )}^{\frac{θ}{θ + 1}} .$$

3. The computer readable medium of claim 1, wherein a remaining time of the markdown period comprises t, and an average seasonality value for the remaining time comprises:
$$σ ( t ) = \frac{1}{t} {\sum }_{u = 1}^{t} s ( u ) .$$

4. The computer readable medium of claim 3, wherein the optimal price comprises:
$${p}^{*} ( t ) = {{p}_{f} ( \frac{θ}{θ + 1} \frac{I ( t )}{k ( T σ ( T ) - t σ ( t ) )} )}^{1 / γ} {( \frac{{I}_{c}}{I ( t )} )}^{α / γ} .$$

5. The computer readable medium of claim 1, wherein assigning a lower price on the price ladder comprises:
select two adjacent prices (p₁ and p₂) from the price ladder, wherein p₁<p*(t)≦p₂; and
set the current price p(t) based on a comparison of a ratio (p*(t)-p₁)/(p₂-p*(t)) to a predetermined threshold parameter.

6. The computer readable medium of claim 1, further comprising:
when the optimal price is approximately equal to the current price of the product, assigning a next lowest price on the price ladder as the current price of the product based on a comparison of a ratio (tₛ-t)/(tₙₑₓₜ-tₛ) to a predetermined threshold parameter, wherein
$${t}_{s} σ ( {t}_{s} ) = \frac{1}{γ} ( \frac{θ {l}_{0}}{K} - ( θ + 1 ) T σ ( T ) ) and θ = - \frac{γ + 1}{α} .$$

7. The computer readable medium of claim 1, further comprising repeating the instructions for each time interval of the markdown period.

8. The computer readable medium of claim 1, wherein the price ladder comprises a plurality of discrete product prices.

9. The computer readable medium of claim 1, wherein the instructions comprise a Structured Query Language.

10. A computer implemented method for determining a revised price for a product over a markdown period, the method comprising:
for a first time interval (t) of the markdown period (T), computing an optimal price (p*(t)) for the product based on an inventory level (I(t)) of the product, wherein the inventory level is based on a ratio of a current on-hand inventory and a maximal on-hand inventory;
determining if the optimal price is less than a current price (p(t)) of the product; and
when the optimal price is less than a current price of the product, assigning a lower price on a price ladder as the current price of the product.

11. The method of claim 10, wherein the inventory level comprises:
$$I ( t ) = {{I}_{0} ( 1 - \frac{σ ( t )}{σ ( T )} \frac{t}{T} )}^{\frac{θ}{θ + 1}} .$$

12. The method of claim 10, wherein a remaining time of the markdown period comprises t, and an average seasonality value for the remaining time comprises:
$$σ ( t ) = \frac{1}{t} {\sum }_{u = 1}^{t} s ( u ) .$$

13. The method of claim 12, wherein the optimal price comprises:
$${p}^{*} ( t ) = {{p}_{f} ( \frac{θ}{θ + 1} \frac{I ( t )}{k ( T σ ( T ) - t σ ( t ) )} )}^{1 / γ} {( \frac{{I}_{c}}{I ( t )} )}^{α / γ} .$$

14. The method of claim 10, wherein assigning a lower price on the price ladder comprises:
select two adjacent prices (p₁ and p₂) from the price ladder, wherein p₁<p*(t)≦p₂; and
set the current price p(t) based on a comparison of a ratio (p*(t)-p₁)/(p₂-p*(t)) to a predetermined threshold parameter.

15. The method of claim 10, further comprising:
when the optimal price is approximately equal to the current price of the product, assigning a next lowest price on the price ladder as the current price of the product based on a comparison of a ratio (tₛ-t)/(tₙₑₓₜ-tₛ) to a predetermined threshold parameter, wherein
$${t}_{s} σ ( {t}_{s} ) = \frac{1}{γ} ( \frac{θ {l}_{0}}{K} - ( θ + 1 ) T σ ( T ) ) and θ = - \frac{γ + 1}{α} .$$

16. The method of claim 10, wherein the method of computing, determining and assigning comprise a Structured Query Language.

17. A pricing markdown optimization system comprising:
a processor;
a memory coupled to the processor, wherein the memory comprises:
a first module that, for a first time interval (t) of a markdown period (T), computes an optimal price (p*(t)) for a product based on an inventory level (I(t)) of the product, wherein the inventory level is based on a ratio of a current on-hand inventory and a maximal on-hand inventory;
a second module that determines if the optimal price is less than a current price (p(t)) of the product; and
a third module that, when the optimal price is less than a current price of the product, assigns a lower price on a price ladder as the current price of the product.

18. The system of claim 17, wherein the inventory level comprises:
$$I ( t ) = {{I}_{0} ( 1 - \frac{σ ( t )}{σ ( T )} \frac{t}{T} )}^{\frac{θ}{θ + 1}} .$$

19. The system of claim 17, wherein a remaining time of the markdown period comprises t, and an average seasonality value for the remaining time comprises:
$$σ ( t ) = \frac{1}{t} {\sum }_{u = 1}^{t} s ( u ) .$$

20. The system of claim 19, wherein the optimal price comprises:
$${p}^{*} ( t ) = {{p}_{f} ( \frac{θ}{θ + 1} \frac{I ( t )}{k ( T σ ( T ) - t σ ( t ) )} )}^{1 / γ} {( \frac{{I}_{c}}{I ( t )} )}^{α / γ} .$$

21. The system of claim 17, wherein assigning a lower price on the price ladder comprises:
select two adjacent prices (p₁ and p₂) from the price ladder, wherein p₁<p*(t)≦p₂; and
set the current price p(t) based on a comparison of a ratio (p* (t)-p₁)/(p₂-p*(t)) to a predetermined threshold parameter.

22. The system of claim 17, further comprising:
when the optimal price is approximately equal to the current price of the product, assigning a next lowest price on the price ladder as the current price of the product based on a comparison of a ratio (tₛ-t)/(tₙₑₓₜ-tₛ) to a predetermined threshold parameter, wherein
$${t}_{s} σ ( {t}_{s} ) = \frac{1}{γ} ( \frac{θ {l}_{0}}{K} - ( θ + 1 ) T σ ( T ) ) and θ = - \frac{γ + 1}{α} .$$
